(19) United States
(12) Patent Application Publication
(10) Pub. No.: US 2002/0148761 A1
(43) Pub. Date: Oct. 17, 2002

(54) Fluid purification system and component and method of using same

(75) Inventor: Sittichai Siriphraiwan, Poway, CA (US)

Correspondence Address: FOLEY & LARDNER, 402 WEST BROADWAY, 23RD FLOOR, SAN DIEGO, CA, 92101

(73) Assignee: Tru Industries, LLC

(21) Appl. No.: 10/162,770

(22) Filed: Jun. 4, 2002

Related U.S. Application Data
(63) Continuation-in-part of application No. 09/595,269, filed on Jun. 15, 2000.
(60) Provisional application No. 60/139,547, filed on Jun. 16, 1999.

(51) Int. Cl. C02F 1/469

(52) U.S. Cl. 210/96.1; 210/143; 210/243; 204/230.2

(57) ABSTRACT

A system and component, as well as a method of using them, according to disclosed embodiments of the present invention, relate to the use of at least one electrode positioned in a flowing fluid having entrained unwanted substances. The electrode is energized electrically to provide current flow in the fluid to produce a sufficient amount of electrical power in the flowing fluid to cause substances in the fluid to be disturbed for effectively treating the fluid.

### CROSS-REFERENCE TO RELATED APPLICATION

The present application is a continuation-in-part patent application of U.S. non-provisional application, entitled “FLUID PURIFICATION SYSTEM, CONTROL SYSTEM AND CIRCUIT,” Ser. No. 09/595, 269 filed on Jun. 15, 2000, which application is related to, and claims priority under 35 U.S.C. § 119(e) of, U.S. provisional patent application Serial No. 60/139, 547, titled “The Concept of Flushing/Cleaning Sequence for Fluid Separation/Purification System and The Flushing/Cleaning Sequence Control Circuit called FCS”, filed Jun. 16, 1999, which is hereby incorporated by reference in entirety. The present application is filed on even date with an application having the title “METHODS FOR PURIFICATION OF FLUIDS,” Serial No. ______, the entire contents of which are hereby incorporated by reference herein.

### BACKGROUND OF THE INVENTION

1. Field of the Invention

The present invention relates in general to a fluid purification system and component, as well as a method of using them. More particularly, the system and component is particularly useful in connection with the purification of water or the like, as well as other fluids.

2. Related Art

There have been many types and kinds of fluid purification systems. For example, reference may be made to the following U.S. Pat. No. 4,851,818 to Brown et al; U.S. Pat. No. 4,956,083 to Tovar; U.S. Pat. No. 5,063,843 to Snee; 5,230,807 to Kozlowski, II; U.S. Pat. No. 5,281,330 to Oikawa et al; U.S. Pat. No. 5,480,555 to Momber; U.S. Pat. No. 5,518,608 to Chubachi; U.S. Pat. No. 5,597,479 to Johnson; U.S. Pat. No. 5,728,303 to Johnson, and U.S. Pat. No. 6,126,797 to Sato et al., which are each incorporated herein in their entirety by this reference as if fully set forth herein.

One popular approach for the purification of water is the reverse osmosis process. Such a process includes the use of a membrane filter to remove undesirable entrained particles. While such systems have proven to be effective, the maintenance and efficiency are disadvantageous for many applications. For example, conventional drinking water reverse osmosis systems used in the home produce , in some instances, only about six gallons of purified water in 24 hours. It would be highly desirous to improve the quantity of purified water for a given period of time such as a 24 hour period of time.

Also, such conventional reverse osmosis systems used in the home often times produce approximately one gallon of purified water from about five gallons of water to be purified. Thus, about four gallons of water are wasted. It would, of course, be greatly advantageous to have a much more efficient system to avoid the unwanted and undesirable waste of expensive water.

Additionally, such conventional reverse osmosis systems when functioning at peak operational effectiveness may be effective to remove unwanted particulates up to only about a 94% efficient at maximum required pressure. However, as the process is used, the membrane filter or other becomes clogged, and thus the efficiency gradually becomes degraded, until the filter must be serviced.

Thus, it would be highly advantageous if the efficient can be maintained or improved, with little or no degradation.

### BRIEF DESCRIPTION OF THE DRAWINGS

The following is a brief description of the drawings:

FIG. 1 is a schematic circuit diagram of a component and system for purifying fluids in accordance with an embodiment of the present invention; and

FIGS. 2-4 are graphs useful in understanding the operation of the system and component of FIG. 1.

### DESCRIPTION OF CERTAIN EMBODIMENTS OF THE INVENTION

A system and component, as well as a method of using them, according to disclosed embodiments of the present invention, relate to the use of at least one electrode positioned in a flowing fluid having entrained unwanted substances. At lease one electrode is energized electrically to provide current flow to produce a sufficient amount of electrical power in the flowing fluid to cause substances in the fluid to be disturbed for effectively treating the fluid.

According to an embodiment of the invention, the current flow is varied in an undulating manner in proportion to the quantity of the substances flowing by the electrode to cause the substances to be disturbed sufficiently to help purify the fluid.

The system includes a reverse osmosis purifier having a membrane filter deposed downstream of the electrode so the disturbed substances tend to avoid clogging or otherwise fouling the membrane filter. As hereinafter described in greater detail, the disclosed embodiment of the present invention has been found to be highly efficient in producing purified water for a given period of time such as a 24 hour period of time. Also, the disclosed embodiment of the present invention has been found to be highly efficient in producing the purified water in such a manner as to avoid undue wasting of the water being treated. Moreover, the disclosed example of the system of the present invention has been found to be highly efficient. It has an efficiency substantially equal to or greater than that of conventional reverse osmosis purifiers, while maintaining the high efficiency at a high level for a long period of time, if not indefinitely, by preventing or greatly reducing the clogging or fouling of the membrane filter of the reverse osmosis purifier forming a part of the system of a disclosed embodiment of the present invention.

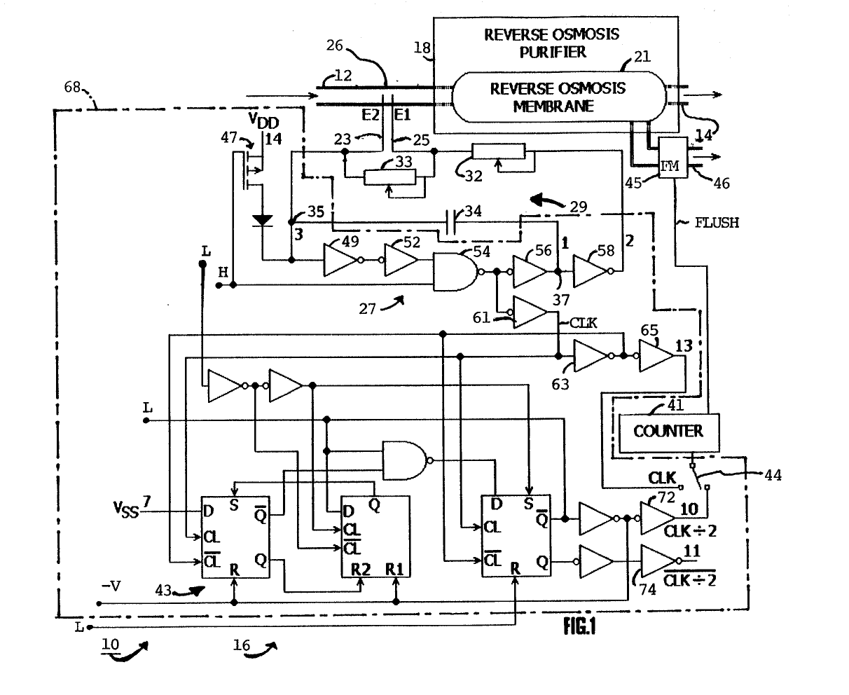

Referring now to the drawings, and more particularly to FIG. 1 thereof, there is disclosed a fluid purification system 10, which is constructed in accordance with an embodiment of the invention. The system 10 is connected to a inlet feed conduit 12 which is adapted to be coupled to a source of feed fluid under pressure such as feed water under pressure that may have been pre-treated such as by pre-filtering. An outlet conduit 14 conveys the purified water from the system 10. It is to be understood that the system 10 may, in accordance with embodiments of the present invention, be used to purify a variety of fluids including, but not limited to, water and other fluids as mentioned in greater detail in the aforementioned co-pending patent application filed on even date.

The system 10 generally comprises an electrical purifying component generally indicated at 16 which disturbs hydrogen in the flowing water to cause it to disassociate and to convert, for example, calcium bicarbonate into calcium carbonate. A reverse osmosis purifier 18 having a membrane filter 21 is used to remove other unwanted particulate substances from the water to be purified. As hereinafter described in greater detail, the disturbance of hydrogen bonds to form calcium carbonates which can freely pass through the filter 21, to prevent, or at least greatly retard, the clogging or fouling of the membrane filter 21 so that the reverse osmosis purifier 18 can operate in a high level of efficiency and maintain that efficiency for long periods of time, if not indefinitely, without the necessity of servicing the membrane filter 21 or requiring the addition of unwanted acids to the reverse osmosis purifier to help maintain its efficiency as currently being done with at least some reverse osmosis purifiers.

Considering now the electrical purifying component 16, the component 16 includes a pair of electrodes 23 and 25 positioned in a conduit 26 coupled between the inlet feed conduit 12 and the inlet to the reverse osmosis purifier 18. It is contemplated that the electrical purifying component 16 may be used by itself to impart electrical power into a flowing fluid, with or without the need for the reverse osmosis 18, for the purpose of treating the fluid.

The component 16 includes an energizing circuit generally indicated at 27 to energize electrically the electrodes 23 and 25 to produce current flow therebetween. A control circuit generally indicated in 29 causes the electrical circuit 27 to vary the current flow in a generally undulating manner in proportion to the quantity of the substances flowing by the electrodes to cause the fluid to be disturbed sufficiently to help purify it. In this regard, in the case of water, hydrogen is disturbed to disassociate it so that calcium carbonate is formed, which is able to flow freely through the membrane filter 21 with little or not fouling of it.

The control circuit 29 includes a variable series resistor 32 connected in series with the electrode 25 of the pair of electrodes 23 and 25. A parallel variable resistor 33 is connected in parallel with the electrodes 23 and 25 to serve as a bypass resistor for the electrodes to help provide an adjustment for a given concentration of substances such as impurities in the fluid. As hereinafter described in greater detail, a capacitor 34 periodically discharges electrical energy in the form of electrical power through the parallel combination of the resistor 34 and the fluid flowing through the conduit 26 between the electrodes 23 and 25, to cause the disturbance of the water flowing through the conduit 26. The resistivity of the fluid determines the discharge time constant and the electrical component 16 thereby adjusts automatically to the concentration of substances in the fluid flowing through the conduit 26, depending upon the resistivity of the fluid in any one instance of time as the fluid varies in concentration as it flows past the electrodes.

Hence, with a heavier concentration, the frequency of the discharges of the capacitor 34 increases automatically to provide a proportionately greater treatment of the fluid. Conversely, with a lighter concentration, the frequency of the discharges decreases proportionately, since only a smaller treatment is required. Thus, the frequency of the discharges vary continuously depending on the concentration of substances in the fluid. It is to be understood that in accordance with another embodiment of the present invention, the frequency could be maintained fixed, for example, at a sufficiently high frequency to provide sufficient treatment for the highest expected concentration of substances within the fluid.

As hereinafter described in greater detail, the energizing circuit 27 causes the capacitor to discharge in alternating directions at a frequency proportional to the amount of concentration of the fluid. By undulating back and forth a degradation of the electrodes 23 and 25 is prevented or at least greatly reduced. In this regard, for some applications, a unidirectional discharge of the capacitor 34 could cause a plating of the metalic electrodes and thus degrade their functionality. However, it is to be understood that while the repetitive reversal of the discharges of the capacitor 34 may not be desirable for some applications, it is contemplated that unidirectional discharges may be useful for some applications and are within the scope of embodiments of the invention.

A counter 41 responds to a signal CLK produced by the energizing circuit 27 each time a capacitor discharge occurs. The counter 41 generates a signal FLUSH for the reverse osmosis purifier 21 once a pre-determined number of cycles of discharging of the capacitor 34 has taken place, so that the membrane filter 21 can be flushed automatically to ensure against any unwanted fouling of the membrane filter 21.

A frequency divider generally indicated at 43 generates clock signal CLK÷2, as well as its complement for use in other portions of the systems. In this regard, a two position switch 44 connects either the CLK signal or the CLK÷2 signal to the counter 41 to enable the membrane flushing to occur after a desired number of discharge treatments of the fluid. A flush mechanism 45 for the reverse osmosis purifier 18 responds to a FLUSH signal from the counter 41 to cause the membrane filter 21 to be flushed to permit unwanted filtered substances to be removed from the system 10 via a flush discharge outlet 46.

In operation, the capacitor 34 charges and discharges alternatively continuously at a frequency determined by the RC time constant of the capacitor 34 and the effective value of the resistance of the combination of the series resistance 32 and the parallel combination of the parallel resistance 33 and the resistivity of the fluid flowing between the electrodes 23 and 25.

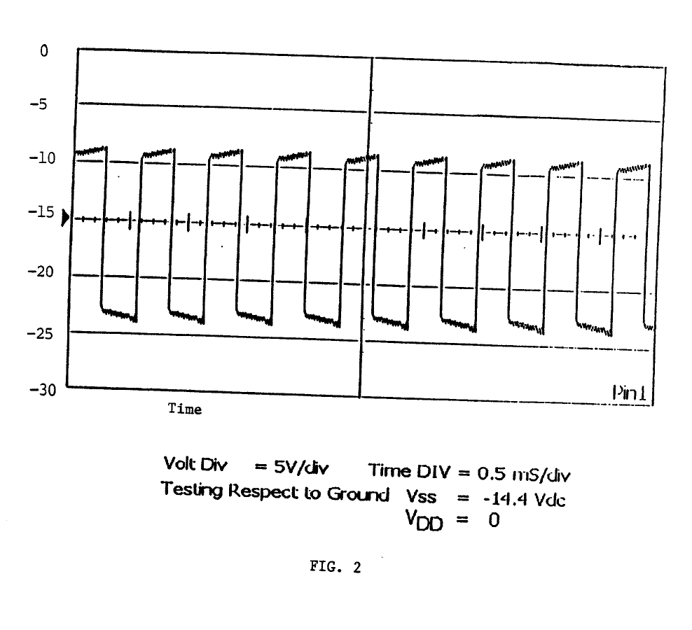

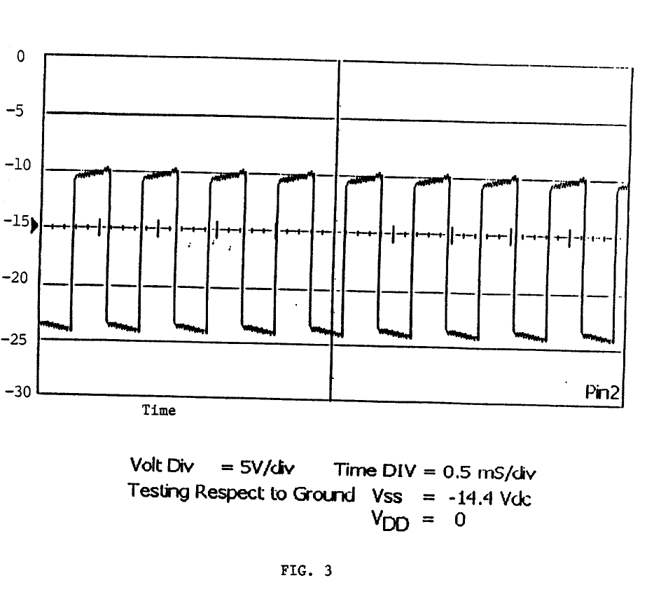

As an example, assume a 250 parts per million (PPM) concentration of entrained substances in feed water flowing through the conduit between the electrodes 23 and 25, the resistivity of the water is 2,000 Ohms, the resistance of the parallel resistor is 3,000 ohms, the resistance of the series resistor 32 is 680 ohms, and the capacitor is 0.1 micro farads. The voltage across the RC circuit of the capacitor 34 and the resistance of the resistors 32 and 33 as well as the resistivity of the water, is reversed continuously. In this regard, as shown in FIGS. 2 and 3, the voltage is switched continuously between about −10 volts on a Pin 1 and about −24.4 volts on a Pin 2, and then about −24.4 volts on Pin 1 and about −10 volts on Pin 2.

The continuous voltage reversals back and forth cause the capacitor 34 to charge and discharge repeatedly at a frequency determined by the RC time constant of the capacitor 34, the resistors 32 and 33 and the fluid resistivity. Thus, as the resistivity varies, the frequency varies proportionately.

For example, for about 5 PPM, the frequency is about 200 Hz. For a concentration of about 5000 PPM, the frequency is about 40,000 Hz. The voltage produced by the capacitor discharges is equal to between about −9 √2 volts and about −12 √2. For at least some applications it is deemed important to have negative swings of voltage to provide sufficient electron flow in the fluid.

The current flow between the electrodes 23 and 25 varies with the cross sectional area of the conduit 26. For a conduit between about one-quarter inch and about two inches in diameter, the current flow is between about 5 milli-amps and about 500 milli-amps. If the diameter of the conduit is about two inches, the current flow is about 500 milliamps.

Thus, for a given size conduit, the voltage and current is selected to provide sufficient power to treat the fluid. In the example of water, the electrical power being discharged into the water cause hydrogen bonds of the substances in the water to be disturbed. For example, the undesirable bicarbonates are thus changed to carbonates which can substantially freely penetrate the membrane filter 21, without fouling it. After exiting the membrane filter 21, the carbonate becomes a solid and precipitates out.

Considering now the manner in which the charging and discharging of the capacitor 34 is controlled, the energizing circuit 27 includes a MOS FET transistor 47, which when it conducts, initiates the operation of the electrical purifying component 16, and provides a fixed logic level high signal at point 35 (Pin 3). The signal V_{DD} is the logic level high, and the signal V_{SS} is the logic level low. When the transistor 47 initially conducts, the high signal is supplied continuously to the point 35 and to the input to an inverter 49 to cause the capacitor 34 to charge in a first direction.

The input to the inverter 49 is high to cause the charge on the capacitor 34 to charge through the series resistor 32, the parallel combination of the parallel resistor 33 and the water flowing past the electrodes 23 and 25. In this regard, an inverter 52 is connected to the output of the inverter 49 and provides an input to a NOR gate 54. An inverter gate 56 is connected between the output of the NOR gate 54 and an input to an inverter 58 which has its output connected directly to the series resistor 32.

Thus, when the input at a point 35 (Pin 3) to the inverter 49 is high, the output (at Pin 2) on the inverter 58 is the opposite level (low), and the output of the inverter 56 (at Pin 1) is the same high level as the level at point 35 (Pin 3).

Thus, Pins 1 and 2 are across the RC resistance-capacitance circuit to be charged and discharged. Initially, Pin 1 is high and Pin 2 is low. Thus, the capacitor 34 charges in the direction from Pin 1 to Pin 2. As the capacitor charges, the voltage at Pin 3 at 35 decreases gradually by voltage transfer from its initial zero potential. Once the voltage on Pin 3 becomes sufficiently low to become a logic low for the input to the inverter 49, the outputs of the logic gates 49, 52, 54, 56 and 58 reverse. Thus Pin 1 switches from high to low, and Pin 2 switches from low to high.

As a result, the potentials across Pins 1 and 2 reverse. However, due to the propagation time of the gates, the Pin 3 side of the capacitor 34 charges substantially to the low voltage of the Pin 2. Once the logic levels reverse for the gates 56 and 58, then the capacitor 34 charges in the opposite direction from Pin 2 to Pin 1. This continues until the voltage on Pin 3 becomes sufficiently high to cause the input to the inverter 49 to return to a logic level high condition to reverse the operation and to commence another cycle of operation.

As a result, the capacitor 34 charges first in one direction, and then in the opposite direction. This operation continues in an undulating manner at a frequency as determined by the resistance-capacitance time constant which varies with the resistivity of the fluid.

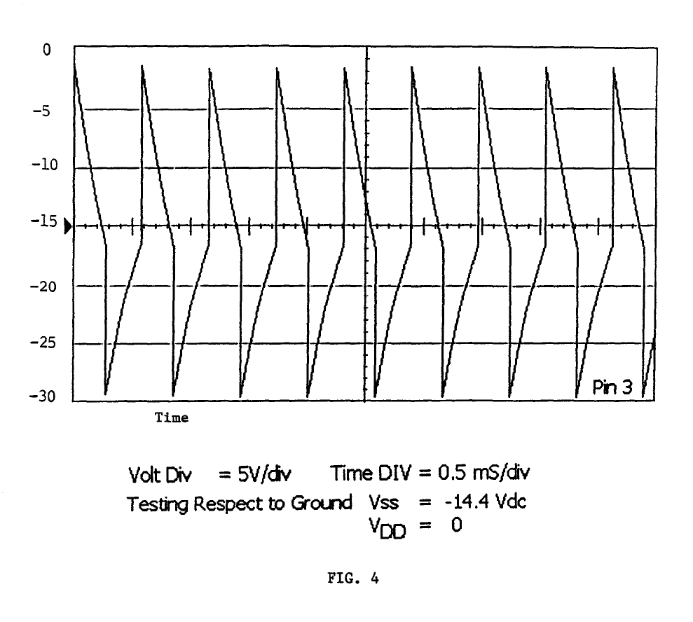

As shown in FIG. 4, the voltage on Pin 3 indicates that the voltage on the capacitor 34 swings between peaks of about V_{SS}=−14.4 volts, which are voltage doubled to be a total of about −28.8 volts peak-to-peak. Thus, the capacitor 34 effectively charges and discharges alternatingly by about −14.4 volts in each direction.

As seen in FIGS. 2 and 3, the voltage on Pins 1 and 2 alternate between about −10 volts and about −24.4 volts. Hence, the capacitor charges in one direction to a voltage of about −14.4 volts on Pin 1, and then alternatingly charges to about −14.4 volts on Pin 2 in the opposite direction to achieve a voltage doubling effect.

Referring now to FIG. 4, when the voltage at Pin 3 is high to initiate a cycle of operation, the capacitor 34 at Pin 3 charges from about −1 volts (about zero) toward the −14.4 volts potential of Pin 2 and reaches about −15.4 volts when the propagation through the gates takes effect, and the voltage reversal takes place on Pins 1 and 2.

Thus, Pin 2 switches from low (−14.4 volts) to high (0 volts). The charge on the capacitor 34 abruptly discharges by about −14.4 volts and thus is at a potential of about −29.8 volts.

The capacitor 34 then charges in the opposite direction toward the potential on Pin 1 to increase the voltage on the capacitor from about −29.8 volts to about −15.4 volts (a net change of about −14.4 volts), until the voltage on the Pins 1 and 2 reverse. Pin 2 returns to low, and Pin 1 returns to high.

As a result, the voltage on the capacitor abruptly discharges in the opposite direction as before, and increases from −15.4 volts to about −1 volt (a net change of about −14.4 volts).

Thereafter, the cycle continues to repeat. Thus, the capacitor 34 charges and discharges repeatedly in alternating directions.

This charging and discharging in opposite directions causes undulating current flow in the fluid flowing through the conduit 26. The frequency of the undulations is determined by the resistivity of the fluid.

A pair of inverters 72 and 74 provide the complementary clock outputs from the frequency divider 43.

The voltage V_{DD} is substantially equal to zero, and the voltage V_{SS} is equal to between about −9 √2 volts and about −12 √2 volts. The series resistor can be adjusted to a variety of values depending upon the concentration of unwanted particulates in the feed fluid.

The electrodes 23 and 25 may be made of stainless steel 304 or 316. According to an embodiment of the present invention, as indicated at 68, a portion of the system 10 as enclosed within broken lines may be implemented by an integrated circuit chip.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

What is claimed is:

1. A system for facilitating the purification of a flowing fluid having entrained unwanted substances, comprising:
at least one electrode for interacting electrically with the flowing fluid; and
an electrical circuit for energizing electrically said electrode to produce a sufficient amount of electrical power in said flowing fluid to cause substances in the fluid to be disturbed for effectively treating the fluid.

2. A system according to claim 1, further comprising a control circuit for causing the electrical circuit to vary said current flow in an undulating manner in proportion to the quantity of the substances flowing by said electrode to cause said substances to be disturbed sufficiently to help purify the fluid.

3. A system according to claim 2, wherein said undulating includes a regular frequency being varied in proportion to the quantity of the substances flowing by said electrode.

4. A system according to claim 3, wherein said control circuit responds to the resistivity of the fluid to vary the current flowing past said electrode.

5. A system according to claim 4, wherein said control circuit includes a capacitor being charged and discharged alternatingly.

6. A system according to claim 1, further including a reverse osmosis purifier having a membrane filter downstream of said electrode so that the disturbed substances tend to avoid fouling said membrane filter.

7. A system for facilitating the purification of a flowing fluid having entrained unwanted substances, comprising:
at least one electrode for interacting electrically with the flowing fluid;
electrical means for energizing electrically said electrode to produce current flow; and
control means for causing said electrical means to vary said current flow in an undulating manner in proportion to the quantity of the substances flowing by said electrode to cause said substances to be disturbed sufficiently to help purify the fluid.

8. A system according to claim 7, wherein said undulating includes a regular frequency being varied in proportion to the quantity of the substances flowing by said electrode.

9. A system according to claim 8, wherein said control means responds to the conductivity of the fluid to vary the current flowing past said electrode.

10. A system according to claim 9, wherein said control means includes a capacitor being charged and discharged alternatingly.

11. A system according to claim 7, further including a reverse osmosis sub-system having a membrane filter downstream of said electrode so that the disturbed substances tend not to foul said membrane filter.

12. A system according to claim 7, further including a second electrode.

13. A purifying component for a reverse osmosis purifier having a filter for facilitating the purification of a flowing fluid having entrained unwanted substances, comprising: a pair of electrodes for interacting electrically with the flowing fluid;
an electrical circuit for energizing electrically said electrodes to produce current flow therebetween; and
a control circuit for causing the electrical circuit to vary said current flow in a undulating manner in proportion to the quantity of the substances flowing by said electrodes to cause said substances to be disturbed sufficiently to help purify the fluid.

14. A purifying component, for facilitating the purification of a flowing fluid having entrained unwanted substances, comprising:
at least one electrode for interacting electrically with the flow fluid;
an electrical circuit for energizing electrically said electrode to produce a sufficient amount of electrical power in said fluid to cause substances in the fluid to be disturbed for effectively treating the fluid.

15. A purifying component according to claim 14, further comprising a control circuit for causing the electrical circuit to vary said current flow in an undulating manner in proportion to the quantity of the substances flowing by said electrode to cause said substances to be disturbed sufficiently to help purify the fluid.

16. A purifying component according to claim 15, wherein said undulating includes a regular frequency being varied in proportion to the quantity of the substances flowing by said electrode.

17. A purifying component according to claim 16 wherein said control circuit responds to the resistivity of the fluid to vary the current.

18. A purifying component according to claim 17, wherein said control circuit includes a capacitor being charged and discharged alternatingly.

19. A purifying component according to claim 18, further including a second electrode.

20. A method of facilitating the purification of a flowing fluid having entrained unwanted substances, comprising:
energizing electrically at least one electrode positioned in the flowing fluid; and
producing a sufficient amount of electrical power in said flowing fluid to cause substances in the fluid to be disturbed for effectively treating the fluid.

21. A method according to claim 20, further including varying said current flow in an undulating manner in proportion to the quantity of the substances flowing by said electrode to cause said substances to be disturbed sufficiently to help purify the fluid.

22. A method according to claim 21, wherein said undulating includes a regular frequency being varied in proportion to the quantity of the substances flowing by said electrode.

23. A method according to claim 22, wherein said varying current flow includes responding to the resistivity of the fluid.

24. A method according to claim 23, wherein said varying current flow further includes charging and discharging alternatingly a capacitor through a pair of electrodes positioned within a flowing fluid.

25. A purifying component according to claim 19, further including means for coupling said capacitor to the electrodes, and means for switching the voltage across the capacitor and the electrodes to reverse the direction of changing and discharging of the capacitor.
